(19) United States
(12) Patent Application Publication
(10) Pub. No.: US 2023/0075643 A1
(43) Pub. Date: Mar. 9, 2023

(54) REAL-TIME DNN EXECUTION FRAMEWORK ON MOBILE DEVICES WITH BLOCK-BASED COLUMN-ROW PRUNING

(71) Applicants: Northeastern University, Boston, MA (US); College of William & Mary, Williamsburg, VA (US)

(72) Inventors: Yanzhi Wang, Newton Highlands, MA (US); Zhengang Li, Boston, MA (US); Bin Ren, Jamestown, VA (US); Wei Niu, Jamestown, VA (US)

(21) Appl. No.: 17/797,610

(22) PCT Filed: Feb. 16, 2021
(86) PCT No.: PCT/US2021/018163

§ 371 Date: Aug. 4, 2022

Related U.S. Application Data
(60) Provisional application No. 62/976,577, filed on Feb. 14, 2020.

(51) Int. Cl. G06N 3/08

(52) U.S. Cl. CPC G06N 3/082

(57) ABSTRACT

BPDNN is a general end-to-end framework to achieve real-time DNN execution on mobile devices. BPDNN supports both CNNs and RNNs. It is based on a novel, fine-grained structured BCR pruning to obtain high execution efficiency without compromising accuracy. BPDNN has two main stages: a compiler-based stage to generate optimized execution codes by leveraging BCR pruning information, and an optimization framework to determine the block size and other hyperparameters based on a decoupling strategy.

### CROSS REFERENCE TO RELATED APPLICATION

This application claims priority from U.S. Provisional Pat. Application No. 62/976577 filed on Feb. 14, 2020 entitled BPDNN: A General, Real-time DNN Execution Framework on Mobile Devices with Block-based Column-Row Pruning, which is hereby incorporated by reference.

### GOVERNMENT SUPPORT

This invention was made with government support under Grant Nos. 1919117 and 1739748 awarded by the National Science Foundation. The government has certain rights in the invention.

### BACKGROUND

The present application relates to a general, real-time DNN execution framework on mobile devices with block-based column-row pruning.

The past five years have witnessed a resurgence of machine learning, specifically in the form of deep learning. Deep Neural Networks (DNNs) such as Convolution Neural Networks (CNNs) and Recurrent Neural Networks (RNNs) serve as the state-of-the-art foundation and core enabler of many key applications such as augmented reality, robotics, high-quality video stream processing, wireless access points, smartphones, wearable devices, smart health devices, etc. [3, 4, 21, 34, 36].

Along with this great success are the increasingly large model size and complex model structure that require tremendous computation and memory resources to fulfill the real-time requirement of aforementioned applications. For example, in video stream processing, real-time execution requires completion of inference operations for 30 frames per second according to a state-of-the-art industry standard. Although modern mobile devices have become increasingly powerful, usually equipped with high-end CPUs and GPUs, they are still considered resource-constrained to support efficient DNN execution. This highly restricts the deployment of large DNNs that can deliver high accuracy on mobile devices.

Take VGG-16 [37], one of the key DNN models in transfer learning, as an example. TVM [6] takes 198 ms to perform an inference of a video frame on an embedded GPU (Adreno 640) with 16-bit floating-point for weights and intermediate results. TensorFlow-Lite (TFLite) [1] takes even longer time (268 ms). TVM and TFLite are two prevalent and representative mobile-oriented, end-to-end DNN inference acceleration frameworks; however, their inference time clearly cannot satisfy the real-time execution requirement.

In the mobile area, many efforts target this issue like DeepMon [18], DeepX [20], DeepSense [42], MCDNN [12], etc. However, most of them do not explore the possible optimization opportunities like computation and memory footprint reductions offered by model compression. A significant performance gap still exists between the peak performance potentially offered by state-of-art mobile devices and what existing systems achieved.

To further mitigate the challenges brought by a large number of computations and memory footprints, and close the performance gap, various DNN model compression techniques have been proposed [11, 13, 24, 29, 31, 32, 40, 44, 46, 48]. Weight pruning is a representative model compression technique that has good potential on mobile acceleration. Another important model compression technique, weight quantization, is less supported in mobile devices especially mobile GPUs. We use 16-bit floating-point representation throughout this disclosure. Weight pruning can be roughly classified into two categories: fine-grained non-structured pruning and coarse-grained structured pruning. A survey of recent weight pruning work leads to the following conclusions: (i) non-structured pruning has the advantage of high compression rate but is typically not compatible with the parallelism in hardware acceleration; (ii) current coarse-grained structured pruning facilitates hardware implementations, but is often subject to accuracy degradation, especially for RNNs. Thus, it is desirable to design a fine-grained structured pruning framework possessing more flexibility while still maintaining regularity.

In accordance with various embodiments, a novel, fine-grained structured pruning termed Block-based Column-Row pruning (BCR pruning) is disclosed to achieve this goal, which is a general method working for both CNNs and RNNs. For a weight matrix in a convolutional (CONV) or fully-connected (FC) layer, we divide it into a number of blocks with an equal size, and apply independent row and column pruning to each block. The remaining weights in each block still form a full matrix. We show that BCR pruning is beyond a mere tradeoff, from both accuracy (pruning rate) and hardware acceleration perspectives. Rather, it can achieve the best of both non-structured and coarse-grained structured pruning. With a moderate 8-256 number of blocks in weight matrix, the accuracy can be similar or even surpass the non-structured pruning under the same pruning rate. The hardware acceleration performance on a mobile device can be close to the coarse-grained structured pruning, far better than the non-structured one. This is achieved through the code optimization capability of compilers for inference acceleration.

Based on the novel BCR pruning scheme, we further develop an end-to-end BPDNN (standing for BCR Pruning-based DNN) acceleration framework, comprising two parts: (1) an execution code generation stage with the compiler-based optimizations enabled by our BCR pruning. This part assists inference acceleration with a given BCR pruned DNN (CNN or RNN) model; and (2) an optimization framework to determine the block size (for each layer) and other hyperparameters, and perform BCR pruning accordingly. This part is performed during the training phase.

BPDNN’s compiler optimizations include a new layer-wise intermediate representation (IR) and associated Domain Specific Language (DSL) that serve as the basis of further optimizations, a matrix reorder to increase the computation regularity and improve both the intra-and inter-thread parallelism, a register-level load redundancy elimination to improve the memory performance, and a novel auto-tuning module to select the best configuration parameters for model executions.

Based on the compiler-assisted acceleration framework, we present an optimization framework to determine the block size (for each layer) and perform BCR pruning accordingly. We propose a decoupling strategy of hyperparameter space to reduce the problem complexity in hyperparameter determination. Block size optimization is decoupled from BCR pruning (and other hyperparameter determination) and is based on compiler-assisted mobile evaluations. We adopt an ADMM-based solution and generalize to BCR pruning, which automatically determines the pruning rate for each block in a layer based on the derived block size.

Briefly, In accordance with one or more embodiments, a novel, fine-grained structured pruning called BCR pruning is disclosed to achieve both high performance and high accuracy, simultaneously. It presents a set of new compiler techniques to generate optimized DNN execution code by leveraging BCR pruning information, including a DSL with a novel layer-wised IR, matrix reorder, register-level load redundancy elimination, and an auto-tuning module. It designs a novel optimization framework to determine the block size and other hyperparameters for BCR pruning based on a decoupling strategy. It integrates everything above and develops a new general end-to-end DNN acceleration framework called BPDNN that supports not only CNNs but also for the first time RNNs on mobile devices.

We compare BPDNN with three state-of-the-art end-to-end DNN acceleration frameworks, Alibaba Mobile Neural Network, TVM, and TensorFlow Lite, and an optimized implementation based on CSR format. Evaluation results demonstrate that BPDNN outperforms them with speedup up to 5.72x, 7.53x, 11.76x, and 4.19x, respectively without any accuracy compromise. We also compare BPDNN with a state-of-the-art FPGA approach (ESE [9]) for RNNs execution. BPDNN’s GPU implementation even outperforms it on GRU, a popular RNN model. These results demonstrate that it is possible to execute high-accuracy DNNs (e.g., VGG-16) on mobile devices in real-time.

### BRIEF SUMMARY OF THE DISCLOSURE

A computer-implemented method in accordance with one or more embodiments is disclosed for compressing a deep neural network (DNN) model by DNN weight pruning and accelerating DNN execution in a mobile device to achieve real-time inference. The method includes the steps of: (a) performing fine-grained structured weight pruning of the DNN model by applying independent row and column pruning to each block of a weight matrix of the DNN model; and (b) applying a compiler-assisted DNN acceleration framework to the DNN model pruned in (a) to generate code to be executed on the mobile device using one or more compiler optimizations.

A computer system in accordance with one or more embodiments includes at least one processor, memory associated with the at least one processor, and a program supported in the memory for compressing a deep neural network (DNN) model by DNN weight pruning and accelerating DNN execution in a mobile device to achieve real-time inference. The program contains a plurality of instructions which, when executed by the at least one processor, cause the at least one processor to: (a) perform fine-grained structured weight pruning of the DNN model by applying independent row and column pruning to each block of a weight matrix of the DNN model; and (b) apply a compiler-assisted DNN acceleration framework to the DNN model pruned in (a) to generate code to be executed on the mobile device using one or more compiler optimizations.

### BRIEF DESCRIPTION OF THE DRAWINGS

FIG. 1 is a simplified diagram illustrating non-structured weight pruning.

FIG. 2 is a simplified diagram illustrating current coarse-grained structured weight pruning schemes.

FIG. 3 is a simplified diagram illustrating a block-based, flexible structured pruning in accordance with one or more embodiments.

FIG. 4 is a graph showing the relationship between accuracy and regularity of BCR pruning in accordance with one or more embodiments.

FIG. 5 is a simplified diagram illustrating a BPDNN system in accordance with one or more embodiments.

FIG. 6 is a simplified diagram illustrating BPDNN’s compiler-based optimization and code generation flow in accordance with one or more embodiments. The compiler takes both DSL and layer-wise IR (as an example in FIG. 7) to generate low-level C/C++ and OpenCL. This low-level code is further optimized with matrix reorder and our BCRC compact model storage (+Reorder), the register-level load redundancy elimination (+LRE), and other optimizations like vectorization (+Vectorization). Finally, the code is further tuned by the auto-tuning module and deployed on mobile devices.

FIG. 7 shows a layer-wised IR example in accordance with one or more embodiments.

FIG. 8 is a simplified diagram illustrating matrix reorder in accordance with one or more embodiments.

FIG. 9 is a simplified diagram illustrating BCRC compact storage in accordance with one or more embodiments.

FIG. 10 is a simplified diagram illustrating register level LRE in accordance with one or more embodiments.

FIG. 11A is a graph illustrating CPU and GPU execution time (y-axis) for a single weight matrix as the number of blocks changes (x-axis). FIG. 11B is a graph illustrating CPU execution time (left y-axis) and accuracy (right y-axis) for VGG-16 on CIFAR10 as the block size changes.

FIGS. 12A-12D are graphs illustrating overall performance, where the x-axis shows DNN models and the y-axis shows average DNN inference time on a single input.

FIGS. 13A-13B are graphs showing MM performance where the x-axis represents row (and column) size.

FIGS. 14A-14B are graphs showing speedup: Opt version over No-Opt on VGG unique CONV layers.

FIGS. 15A-15B are graphs showing matrix reorder, where the x-axis represents is row id.

FIGS. 16A-16B are graphs showing register load counts before and after LRE. (R1 to R3 in RNN are layers with different matrix sizes from GRU, 152 1024, 512 1024, 1024 1024. CNN uses unique CONV layers from VGG.)

FIG. 17 is a graphs showing extra data overhead comparing BCRC/CSR with varied matrix sizes (x-axis) and pruning rates.

FIGS. 18A-18B are graphs showing portability evaluation with VGG-ImageNet.

FIGS. 19-23 show Tables 1-5, respectively.

FIG. 24 is a block diagram illustrating an exemplary computer system in which the methods described herein in accordance with one or more embodiments can be implemented.

### DETAILED DESCRIPTION

### DNN Weight Pruning

As the most straightforward and efficient neural network compression technique, weight pruning removes the redundant or less important weights to reduce storage and computation costs, thereby accelerating the inference speed. According to the structure of pruned models, there are mainly two DNN pruning approaches: non-structured pruning and structured pruning.

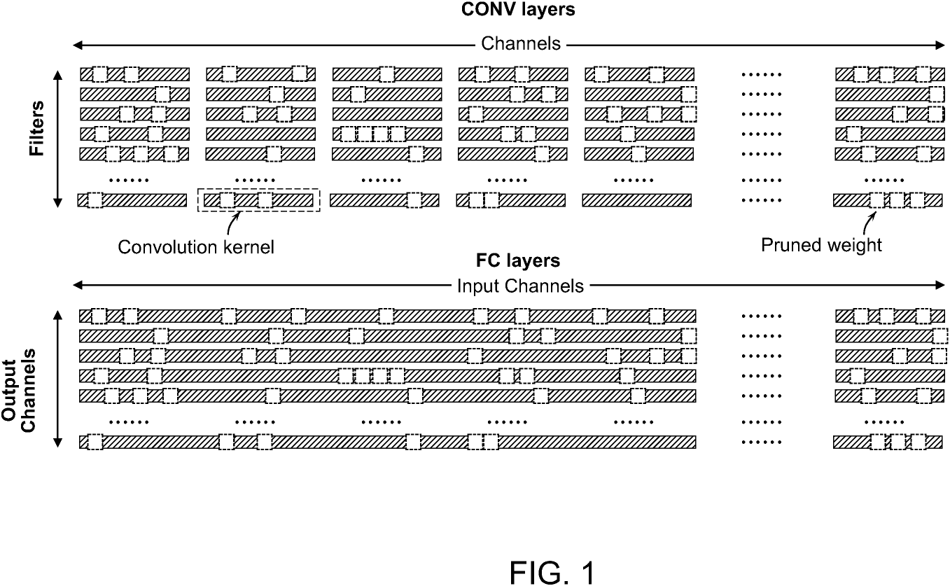

Non-structured pruning is shown in FIG. 1. Non-structured pruning results in a fine-grained, irregular network where weights can be pruned at arbitrary locations. Early works are represented by [10, 11], in which an iterative, heuristic method is utilized. Due to the intrinsically non-optimized approach of the above method, DNN pruning can only achieve limited, non-uniform compression rates with moderate accuracy. Further study of the powerful ADMM optimization framework [35,44] improves the performance of pruning that high compression rates and promising accuracy can be achieved simultaneously. However, it is difficult to achieve better hardware performance due to the irregularity in memory access and computation. First, a non-structured pruned model is usually stored in the compressed sparse row (CSR) format to save storage cost, and the model weight needs indirect irregular memory access that is easy to incur cache misses thus not friendly to the modern memory hierarchy. Second, the non-structured sparse weights computations require heavy control-flow instructions, which degrades instruction-level parallelism and causes stall or complex workload on highly parallel architectures.

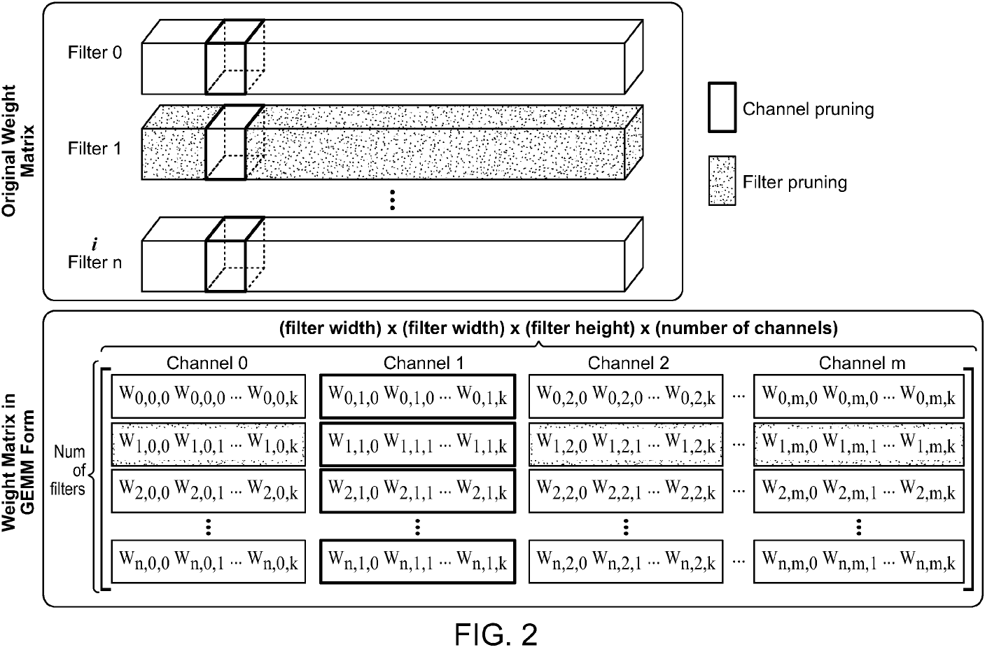

Structured pruning: To overcome the limitations of non-structured pruning, recent works [14,32, 40] considered to incorporate regularity or “structure” in weight pruning, including filter pruning and channel pruning that target at generating coarse-grained, regular and smaller weight matrices to eliminate overhead of weight indices and achieve higher acceleration in CPU/GPU executions. As FIG. 2 shows, filter pruning removes the entire filter(s), while channel pruning removes whole channel(s). For convolution computations, weight matrices usually transform into general matrix multiplication (GEMM) form as FIG. 2 illustrates. Accordingly, filter pruning can also be termed as row pruning since it corresponds to removing one row of the weight matrix, and channel pruning corresponds to reducing multiple consecutive columns. Current coarse-grained structured pruning approaches suffer from notable accuracy loss due to the aggressive pruning schemes that the entire filter/channel information is lost. As a result, it usually has limited compression rates and low accuracy, as well as limited applicability as most work focus on CONV layers only. For FC layers (applied partially in CNN and majorly in RNN), coarse-grained structured pruning is applicable but not desirable due to the same reason above, especially for time-based RNN since one pruned row/column in an RNN will not be utilized for all time stamps, causing major accuracy degradation.

### Mobile Acceleration of DNNs

Due to the importance, many efforts focus on developing efficient DNN inference acceleration frameworks on mobile devices recently like DeepEar [22], DeepX [20], MCDNN [12], DeepMon [18], DeepSense [42], Deep-Cache [41], etc. TVM [6], TFLite [1], and Alibaba Mobile Neural Network (MNN) [2] are three state-of-the-art end-to-end DNN acceleration frameworks with the highest execution efficiency as BPDNN targets. Most of the prior work cannot fully utilize model compression techniques as BPDNN. There are some other efforts that explore model compression to accelerate the DNN execution including the Liu et al. work [26], DeftNN [15], SCNN [33], and AdaDeep [28]. However, they either require new hardware support, or need a trade-off between performance and accuracy, or do not target mobile platforms.

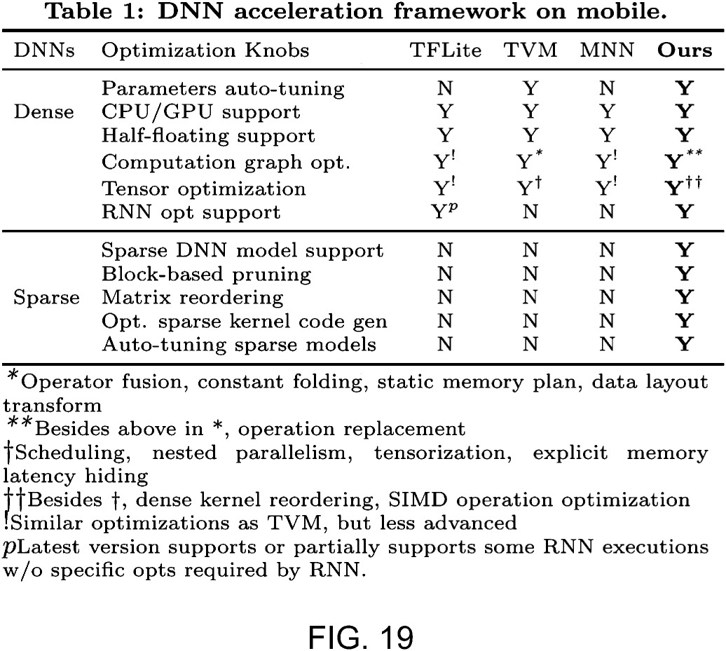

Table 1 (FIG. 19) compares the major optimizations in TFLite, TVM, and MNN with BPDNN (last column labelled “Ours”). Others are not shown because these three end-to-end frameworks share the closest target with BPDNN. Please notice that although these three frameworks are general, they cannot support efficient RNN execution as BPDNN.

### Block-Based Column-Row (BCR) Pruning and BPDNN Overview

### Unified View of CNN/RNN Computation

The layer-wise computations of CNN include CONV layer computations with different kernel sizes, mostly 3 × 3 and 1 × 1 kernels (larger kernels such as 5 × 5 kernels can also be utilized for input layer as example), and FC layer computations, which are essentially matrix-vector multiplications. On the other hand, computations in RNNs (e.g., LSTM or GRU) are mostly FC layers (matrix-vector multiplications). It is well known that the CONV in DNNs is commonly transformed into GEMM, i.e., the multiplication of a weight matrix and an input matrix. GEMM is commonly utilized in DNN acceleration frameworks [1, 6]. In this way, all computation types in CNN and RNN can be unified as matrix-vector or matrix-matrix multiplication, and will be treated in a unified manner in BCR pruning.

### Motivation of Fine-Grained BCR Pruning

From a survey of recent research works, we have reached the following conclusions: (i) non-structured pruning has the advantage of high compression rate but is typically not compatible with the parallelism in hardware acceleration; (ii) current coarse-grained structured pruning facilitates hardware implementations but is often subject to accuracy degradation. The accuracy degradation in structured pruning is especially significant for RNNs. When a whole row or column in a weight matrix (input, state-transition, or output matrix) of RNN is pruned, it assumes that a whole input or output entry is not useful at all-time steps. This is easy to cause intolerable accuracy loss. As a result, it is desirable to design a fine-grained structured pruning framework possessing more flexibility (and thus higher accuracy) while still maintaining regularity (for facilitating hardware acceleration).

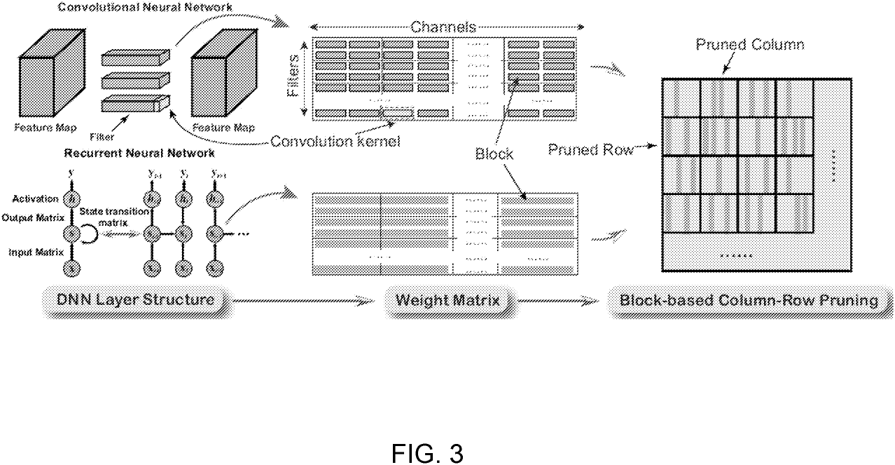

We propose BCR pruning to achieve this goal, which applies to different computation layers in CNN and RNN. For a weight matrix in GEMM or FC layer computation, we divide it into n x m blocks with equal size. We apply independent row and column pruning on each block, with potentially different pruning rates (number of pruned rows/columns) in each block, to ensure high flexibility. The remaining weights in each block still form a full matrix. An illustrative example of the process is shown in FIG. 3. At the first glance, BCR pruning is a tradeoff between the most flexible non-structured pruning and the most rigid structured pruning that prunes whole rows/columns. It becomes the former with block size 1-by-1 and becomes the latter with block size the same as the whole weight matrix. We will see in the following that BCR pruning is beyond a mere tradeoff, from both accuracy (pruning rate) and hardware acceleration perspectives, especially with the aid of compiler.

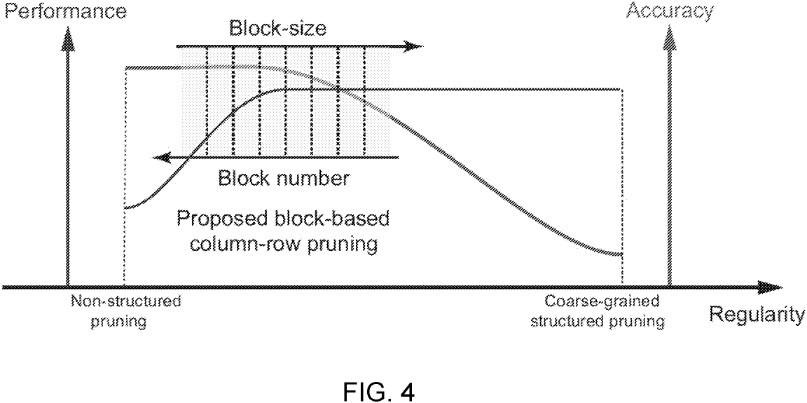

From the accuracy perspective, we observe that BCR pruning obtains a significant accuracy enhancement (under the same pruning rate) compared with the most coarse-grained structured pruning that eliminates whole rows/columns, even with a small number of blocks. This is validated in various datasets under the same (ADMM-based) pruning algorithm, using CIFAR-10 as an example and shown conceptually in FIG. 4. With a moderate 8-256 number of blocks in weight matrix, BCR pruning’s accuracy can be similar or even surpass non-structured pruning under the same pruning rate. This is because non-structured pruning has a large search space, and it often takes too long time to converge to a desirable solution. This accuracy phenomenon is illustrated conceptually in FIG. 4.

From the hardware acceleration perspective, with a moderate 8-256 number of blocks in weight matrix, the hardware acceleration performance on a mobile device can be close to the coarse-grained structured pruning, far better than non-structured pruning. The most important reason is that the remaining parallelism in each block (after pruning) is still much higher than that in a mobile CPU/GPU. Taking a 1024x1024 weight matrix as an example. Suppose 64 blocks are utilized and a further 8x BCR pruning is adopted, the average number of remaining weights per block is 2,048. These 2,048 weights form a weight matrix that is still large enough for parallelization on mobile CPU/GPU. Moreover, the overhead in column/row index storage, input and output transition, etc. can be effectively reduced through code optimization capability of compiler, and load balancing can be maintained. As a result, with the help of compiler, the hardware performance can be guaranteed under fine-grained BCR pruning.

In summary, FIG. 4 shows that BCR pruning is “beyond a mere tradeoff” of non-structured and the most coarse-grained structured pruning. Rather, it can achieve the best of both schemes, i.e., both high accuracy (pruning rate) and high hardware performance, under a compiler-assisted acceleration framework.

### Overview of the BPDNN Framework

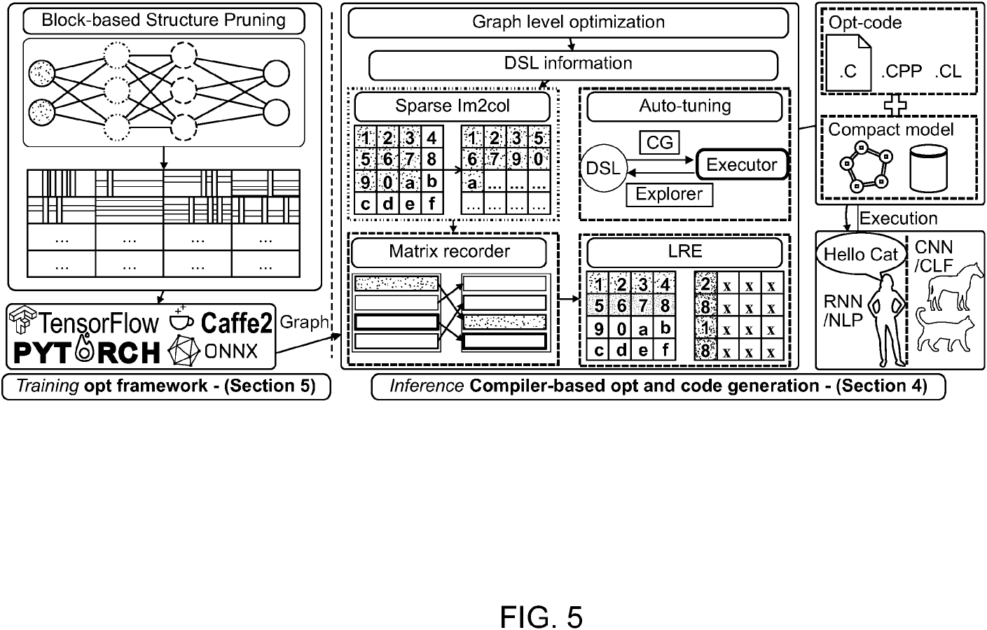

FIG. 5 illustrates the overview of our end-to-end BPDNN acceleration framework in accordance with one or more embodiments, which comprises two major parts: (1) an execution code generation stage with the compiler-based optimizations enabled by our BCR pruning (discussed below). This part assists inference acceleration with a given BCR pruned DNN (CNN or RNN) model and is performed offline; and (2) an optimization framework to determine the block size (for each layer) and other hyperparameters, and perform BCR pruning accordingly (discussed below). This part is performed during training phase.

At a high-level, BPDNN represents the DNN models as computational graphs with a set of associated optimizations like TVM [6]. Based on this optimized baseline and by leveraging our BCR pruning, this work focuses on proposing a layer-wised Intermediate Representation (and a Domain Specific Language) for each DNN layer, and designing multiple optimization and code generation techniques. Our proposed optimizations include an efficient CONV to matrix multiplication transformation (i.e., Im2col for CNN only), a matrix reorder, a compact model storage format, a register-level load redundancy elimination, and an optimized auto-tuning. These optimizations are general, applicable for both CNNs and RNNs (and associated computation types), working on both CPUs and GPUs on mobile devices. The optimized RNN and CNN models with BCR pruning can be used for various real-time workloads like natural language processing, computer vision, and video processing.

### Inference and Code Optimization

BPDNN relies on a compiler-based framework to generate optimized inference code and efficiently execute compressed DNN models on various resource-constrained mobile devices. This framework comprises two-level optimizations: (1) optimizations on computational graphs that explore coarser level opportunities among multiple layers, and (2) optimizations on each DNN layer. For the former, BPDNN adopts an enhanced TVM [6] (and Tensor Comprehensions [38])-like approach with all major optimizations summarized in Table 1.

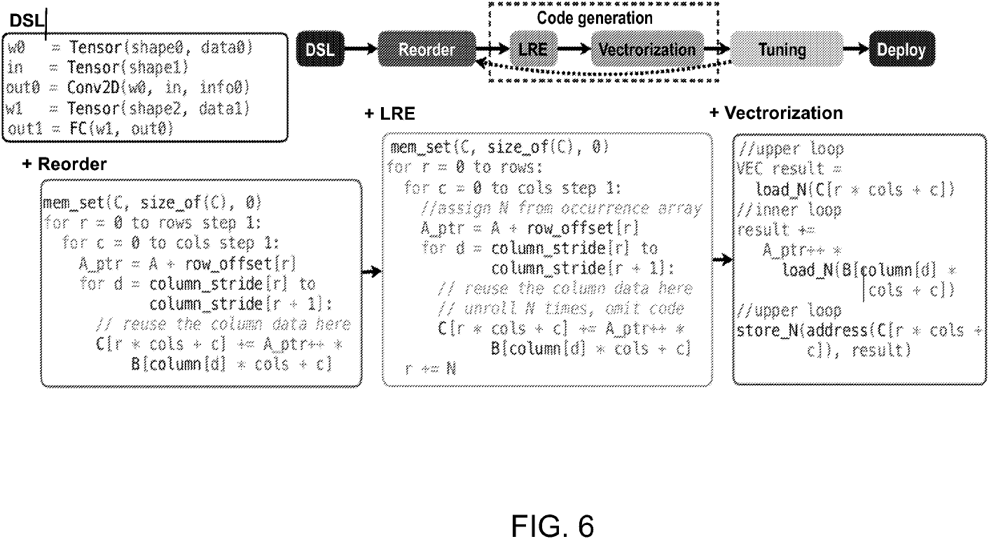

This section focuses on the optimizations performed on each DNN layer enabled by BCR pruning. Particularly, these optimizations aim to address the performance challenges in pruned DNN executions: thread divergence and load imbalance among threads, redundant memory access, and unnecessary zero storage. FIG. 6 shows an overview and a simplified code transformation and generation example of BPDNN compiler.

### DSL and Compiler-Based Framework

DNN models contain layers with varied computations, such as CONV, FC, pooling, etc. BPDNN offers a high-level Domain Specific Language (DSL) to specify the functionality (e.g., CONV or FC), input (e.g., model, image, and intermediate results), output (e.g., intermediate and final results), and a layer-wised Intermediate Representation (IR) with BCR pruning information. The input and output are in the form of tensors with different shapes. BPDNN’s DSL also provides a Tensor function for users to create matrices (or tensors).

Essentially, this DSL is equivalent to the computational graph (i.e., DSL is another high-level set of functions to model the data-flow of DNN models) and they can convert to each other conveniently. DSL offers users the flexibility of using existing DNNs or creating new DNNs, improving the programmability (or productivity) in DNN programming. If a DNN already exists, BPDNN transforms it to an optimized computational graph and translates this graph to DSL. Otherwise, the user writes the model code in our DSL, translates it back to a computational graph, performs high-level optimizations, and regenerates the optimized DSL code.

FIG. 6 shows a DSL example with two connected layers: Conv2D and FC. Conv2D takes a model tensor (w0) with the shape of shape0 and data of data0 and an input feature map (in) with the shape of shape1, and generates a result tensor (out0). Next, FC takes a model tensor (w1) with the shape of shape2 and data of data1 and previous Conv2D output, and generates a new result tensor (out1).

The BPDNN compiler translates DSL to low-level C++ (on CPU) and OpenCL code (on GPU), and optimizes the low-level code with a set of BCR pruning enabled optimizations, such as matrix reorder, compact data storage, load redundancy elimination, configuration parameters auto-tuning, and vectorization (as FIG. 6). The generated code is deployed on mobile devices.

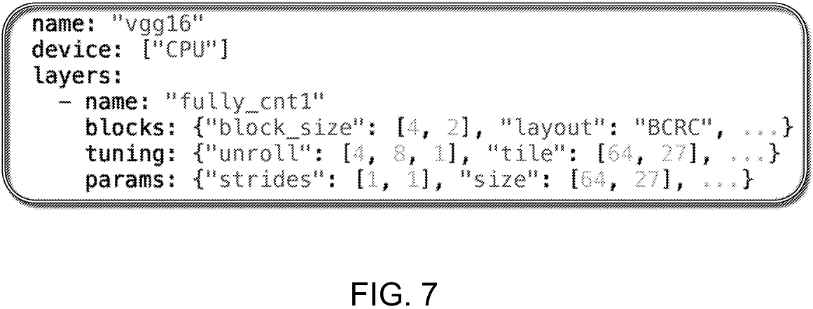

Layer-wised IR: The key design of our DSL is prune-ware. It allows integrating BCR pruning information to the kernel computation by a layer-wised IR (e.g., info in the DSL example in FIG. 6). This IR provides the compiler necessary information to perform the subsequent BCR pruning-based code optimization. FIG. 7 shows more details of this IR. It is a FC layer (full_cnt1) from vgg16, and this IR is for CPU optimization. It mainly consists of three aspects of information: block information (e.g., block_size and layout), tuning information (e.g., unroll factor, and tiling size), and other basic information (e.g., strides). This design is general, potential to support more advanced pruning and to represent other sparsity information for further performance optimization.

### Matrix Reorder

BCR pruning partitions the whole model kernel matrix into blocks with different pruning configurations. Without any further optimization, it will encounter the well-known challenges for sparse matrix multiplications, i.e., heavy control-flows within each thread, load imbalance among multiple threads, and irregular memory access. Although there are many existing efforts on sparse matrix multiplications [8, 26], they cannot leverage the optimization opportunities offered by BCR pruning.

To address this issue, we propose a matrix reorder method based on BCR pruning. Our later evaluation demonstrates that this kind of compression and acceleration co-design significantly outperforms existing general sparse matrix multiplication optimizations that do not take the pruning characteristic into account.

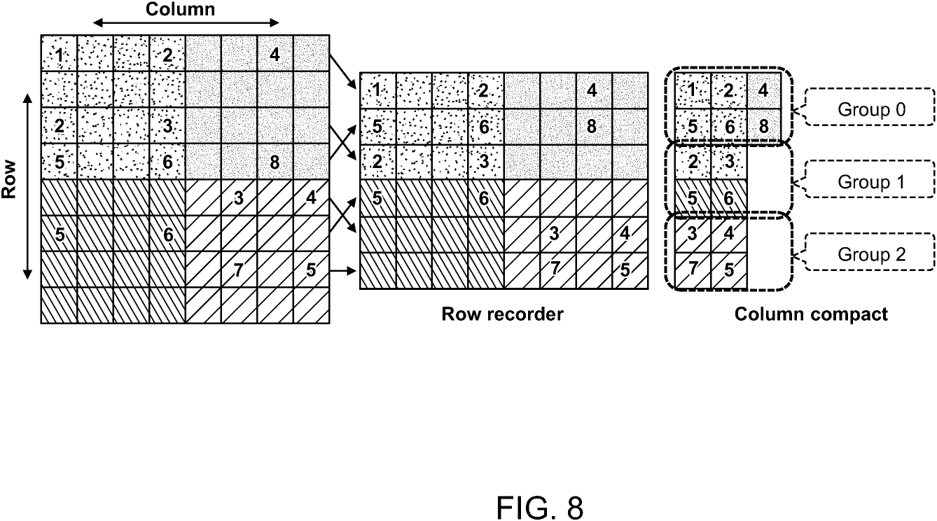

FIG. 8 illustrates the basic idea of matrix reorder. Because BCR pruning removes all kernel weights in certain columns and rows within a block, the remaining weights only appear in other rows and columns with a certain degree of regularity. Based on this insight, matrix reorder first reorders the rows (e.g., filters in CNN) by arranging the ones with the same or similar patterns together. Next, it compacts the weights in the column direction (e.g., kernels in CNN). At last, the rows with the same or similar computations are grouped together.

FIG. 8 shows a simplified example with only three groups and two rows in each group. Actual CNN and RNN models usually have tens of groups with hundreds of rows in each group. Each group is processed by all threads in parallel, and each thread is in charge of multiple continuous rows. Thus, the computation divergence among these threads is significantly reduced.

### Compact Model Storage (BCRC)

After the matrix reorder, BPDNN stores the model in a compact format by leveraging the BCR pruning, called a BCRC (Blocked Column-Row Compact) format. BCRC aims to avoid zero-weights storage as CSR with an even better compression ratio by adopting a hierarchical index structure to remove redundant column indices generated by BCR pruning. BCRC helps to save the scarce memory-bandwidth of mobile devices.

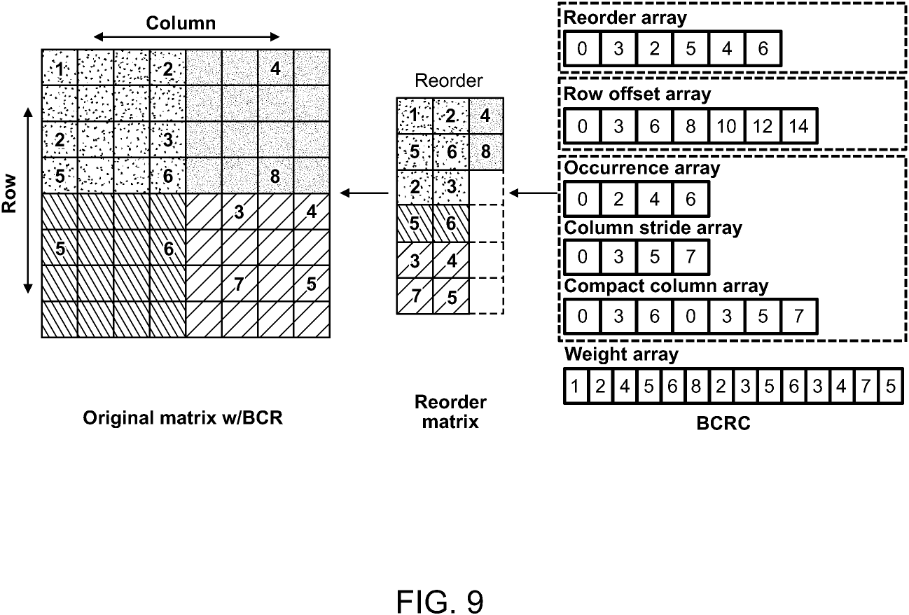

FIG. 9 shows a simplified example of BCRC. The original matrix with BCR pruning (left-hand side) is transformed to a compact matrix by reorder (middle), and then stored in BCRC (right-hand side). BCRC consists of six arrays: reorder, row offset, occurrence, column stride, compact column, and weights:

Reorder array denotes a mapping between the row id in the original matrix and the one in the reordered matrix. For example, the number 0 and 3 (in reorder array[0] and [1]) denote that the row0 and row3 in the original matrix are placed in the 0 and 1 rows, respectively, after the reorder.

Row offset array denotes the offset of each row when the reordered matrix is linearized into a 1-d array (i.e. weights array). For example, the 0 and 3 (in row offset array [0] and [1]) mean that the row0 and rows in the reordered matrix start from index 0 and 3, respectively, in the 1-d weights array.

The key advantage of BCRC over CSR is to use a more compact way to store the column index based on the observation that multiple rows may share the same column index due to the BCR pruning. It uses three arrays to achieve this: occurrence, column stride and compact column. Here is the basic idea. Compact column array stores the column index of each row in the reordered matrix. The column stride array denotes the offset of the column index in each row. For example, the 0 and 3 (in column stride array[0] and [1]) mean that the first row in reordered matrix has the column index [0, 3, 6] (i.e. from compact column array [0] to [2 (i.e., 3 - 1)]). If two rows share the same column index, compact column array only stores once. The occurrence array is used to specify which rows have the same column index. For example, the first two numbers [0, 2] (in occurrence array [0] and [1]) show row0 and rows have the same column index [0, 3, 6].

Weights array is to store the matrix weights in a linearized 1-d array.

The low-level code starts to support computations on BCRC from +Reorder in FIG. 6.

### Register Load Redundancy Elimination

Poor memory performance caused by the irregular and redundant memory access is another key bottleneck of efficient DNN execution. BPDNN employs two further optimizations to address this challenge: (1) matrix tiling (with the best tiling size decided by auto-tuning) to improve the load/store efficiency from memory to register, and (2) register-level load redundancy elimination (LRE) to reduce the number of register loads. This section focuses on the second one because of its novelty.

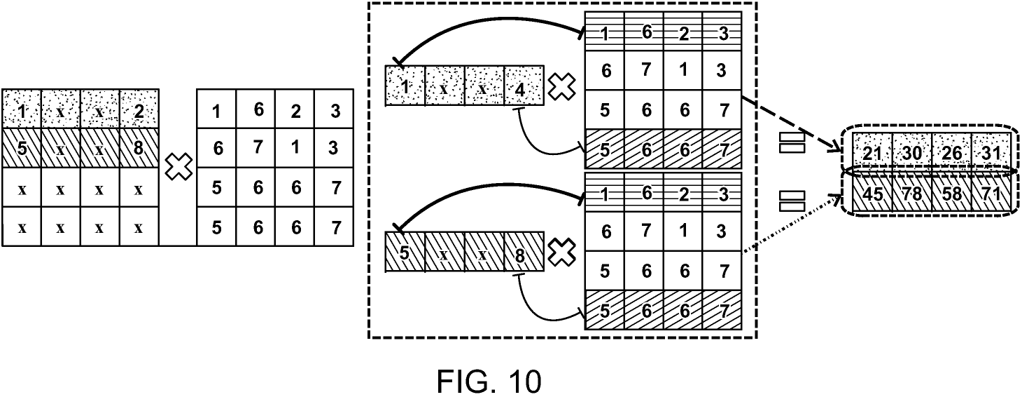

FIG. 10 shows a register-level RLE example, in which both [1,4] and [5,8] (i.e. the first two rows) in the kernel matrix require the first and the last rows of the input feature map. Thus, the first and last rows of the input feature map could be loaded into the register once and reused by the first two rows of the kernel matrix. BPDNN achieves this by a proper loop unrolling transformation (as shown in FIG. 6, +LRE), because this LRE opportunity is decided by the kernel matrix that is already known during the compilation time.

It is worth to notice that although it is easy to implement this LRE for dense models, it is challenging (even not possible) for randomly pruned models. Our BCR pruning re-enables LRE, showing the benefit of a model compression and compiler optimization co-design.

### Auto-Tuning and Other Optimizations

BPDNN also includes some other optimizations discussed below that improve execution performance.

Auto-tuning: DNN execution usually involves many configurable performance parameters, such as the data placement on GPU heterogeneous memory, matrix tiling sizes, loop unrolling factors, etc. Tuning them manually is tedious and error-prone. BPDNN thus includes an auto-tuning module based on Genetic Algorithm to explore them automatically. In particular, after BCR pruning, different model kernels have varied sizes and shapes that require different tiling shapes and thread block settings. BPDNN employs this auto-tuning module to extensively explore the best configurations for all DNN kernels. Comparing to existing auto-tuning approaches in TVM, BPDNN’s auto-tuning exploits better parallelism because its foundation, Genetic Algorithm allows to start the parameter search with initializing an arbitrary number of chromosomes. BPDNN’s auto-tuning is more efficient.

Vectorization. BPDNN also vectorizes CPU and GPU code automatically with ARM NEON and OpenCL, respectively. CPU and GPU have different (and limited) numbers of vector registers. To fully utilize them while minimizing the register spilling, BPDNN carefully designs another level of loop unrolling to pack more computations together. Combining this optimization with the regularity given by BCR pruning and matrix reorder, BPDNN generates more efficient vector codes comparing to other DNN acceleration frameworks.

Computation Transformation. BPDNN transforms CONV to sparse matrix multiplication, which requires to convert CONV weights to a GEMM-based matrix format (i.e, the step of Im2col in FIG. 5). Im2col is memory-bound as it only reads weights and expands them to a larger matrix. BPDNN optimizes Im2col by skipping the matrix row during expanding, when a certain weight column is completely pruned.

### Optimization Framework

Based on the compiler-assisted acceleration framework, we present the optimization framework to determine the block size (for each layer) and other hyperparameters (e.g., the pruning rate for each layer), and perform BCR pruning accordingly. The number of hyperparameters is very large, making the overall optimization problem challenging.

We propose a decoupling strategy of the hyperparameter space to reduce the problem complexity in hyperparameter determination, based on the following two observations. First, the testing accuracy is higher in general when the block size is smaller and vice versa. Second, the mobile acceleration performance depends on the block size (number of blocks) and is independent of actual weight values. From these two observations, we decouple block size optimization from BCR pruning and other hyperparameter determinations. More specifically, we perform mobile testing using the compiler-assisted acceleration to evaluate hardware performances with different block sizes, and select the smallest block size such that the performance degradation (compared with pruning whole rows/columns under the same pruning rate) is within a predefined threshold value. This step is independent of DNN training or actual BCR pruning, and should run much faster. The underlying principle is that the derived block size will likely provide the highest accuracy while satisfying the hardware performance requirement. More elaborations about the decoupled optimizations are provided in the following.

### Block Size Determination Framework

The block size (number) optimization is based on mobile testing using the compiler-assisted acceleration framework. The goal is to select the smallest block size for each layer such that the performance degradation is within a tolerable range. As different DNN layers have different sizes, there may be different desirable block numbers accordingly. Therefore, we are essentially deriving a relationship function between different layer size (structure) and desirable block number (size) that satisfies the performance constraint. We perform evaluation on mobile CPU/GPU in a layerwise manner, using synthesized BCR pruning patterns with a reasonable pruning rate for each target layer, and then select the desirable block size. This procedure is offline, independent of training/pruning and executes much faster. The block size determination procedure of a representative DNN on ImageNet or CIFAR-10 datasets can complete within an hour using actual mobile testing.

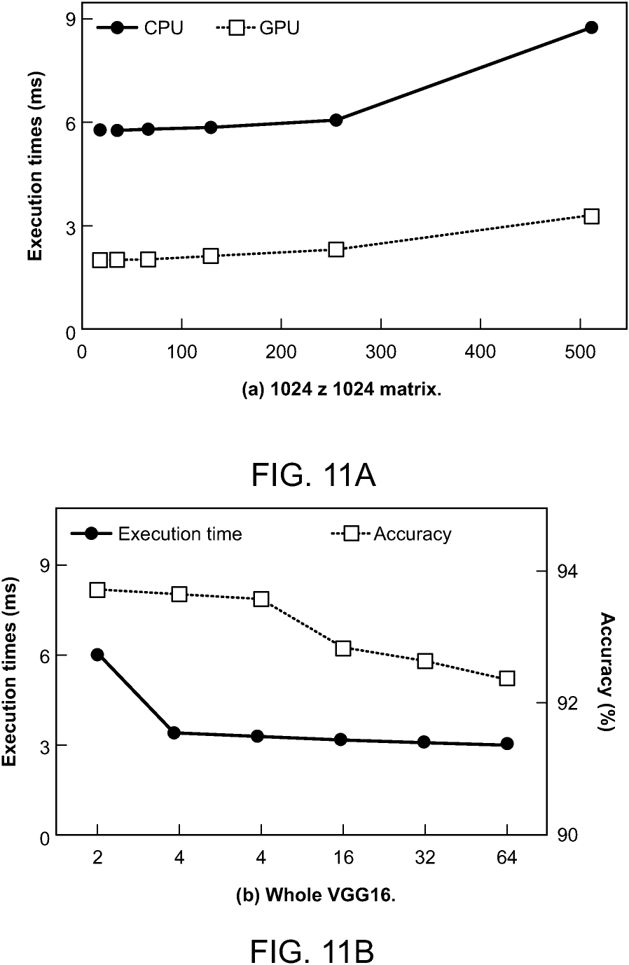

FIG. 11A shows an illustrative example using a 1024x1024 weight matrix, under 10x BCR pruning. As increasing the block count, the execution time remains stable before it reaches 256, and increases dramatically after that point. FIG. 11B shows the execution time and accuracy trend as changing the block size for VGG-16 trained on CIFAR-10. The x-axis shows the first dimension of the block size, and the second dimension is fixed as 16. As increasing the block size, the execution time drops quickly at first until reaching a relatively stable level (around 3 ms), and the inference accuracy drops slowly at first and quickly after a point. Therefore, it is possible for us to find a specific block size (e.g., 4x16) that yields optimal execution time without compromising accuracy.

### BCR Pruning using ADMM

Based on the derived block size (number) for each DNN layer, we will perform BCR pruning along with the determination of the remaining key hyperparameters: target pruning rate for each layer. We adopt state-of-the-art weight pruning algorithm using ADMM (Alternating Direction Methods of Multipliers) and generalize to BCR pruning, for two reasons: The first is that it achieves (one of) the highest weight pruning rates satisfying accuracy constraint [35, 43-45]. The second is that the ADMM-based framework, when generalized to BCR, can automatically determine the desirable column and row pruning rates for each block given a predefined pruning rate for a whole weight matrix (for a specific layer).

BCR Pruning Problem Formulation and ADMM-based Solution: For an N-layer DNN of interest, let Wi and bi denote the weights and biases of the i-th layer respectively. We minimize the loss function associated with the DNN model, subject to specific block-based sparsity constraints on the weights in the corresponding layers, i.e., minimize

$$\begin{matrix}{\text{minimize}}_{\left\{{\text{W}}_{i}\right\} , \left\{{\text{b}}_{i}\right\}} & f \left({\left\{{\text{W}}_{i}\right\}}_{i = 1}^{N} , {\left\{\text{b} {}_{i}\right\}}_{i = 1}^{N}\right) , \\ \text{subject to} & {\text{W}}_{i} ∈ {\text{S}}_{i ,} i = 1 , ... , N\end{matrix}$$

where Si is the set of Wi with a specific hardware-aware BCR sparsity constraint αi.

Hardware-aware BCR sparsity: Consider the weight matrix of the i-th DNN layer divided into n x m blocks. The constraint on the weight matrix is that, the portion of the total number of zero weights in all blocks to the total number weights is no less than αi (the sparsity constraint). The remaining weights in each block are distributed in a regular column and row structure.

Corresponding to every set Si, i = 1, ... , N, we define the indicator function

$${g}_{i} \left({\text{W}}_{i}\right) = \left\{\begin{matrix}0 & \text{if} {\text{W}}_{i} ∈ {\text{S}}_{i} , \\ + ∞ & \text{otherwise}\end{matrix}\right) .$$

Problem (1) with constraint cannot be solved directly by classic stochastic gradient descent (SGD) methods [19] as original DNN training. However, the ADMM regularization can reforge and separate the problem, then solve them iteratively [16,27]. First, we reformulate the problem (1) as follows:

$$\begin{matrix}{\text{minimize}}_{\left\{{\text{W}}_{i}\right\} , \left\{{\text{b}}_{i}\right\}} & f \left({\left\{{\text{W}}_{i}\right\}}_{i = 1}^{N} , {\left\{{\text{b}}_{i}\right\}}_{i = 1}^{N}\right) + {\sum }_{i = 1}^{N} {g}_{i} \left({\text{Z}}_{i}\right) , \\ \text{subject to} & {\text{W}}_{i} = {\text{Z}}_{i} , i = 1 , ... , N ,\end{matrix}$$

where Zi is an auxiliary variable. Then, with formation of augmented Lagrangian [5],the problem (2) can be decomposed into two subproblems (3) and (4),

$${\text{minimize}}_{\left\{{\text{W}}_{i}\right\} , \left\{{\text{b}}_{i}\right\}} f \left({\left\{{\text{W}}_{i}\right\}}_{i = 1}^{N} , {\left\{{b}_{i}\right\}}_{i = 1}^{N}\right) + {\sum }_{i = 1}^{N} \frac{{ρ}_{i}}{2} \left‖{\text{W}}_{i} - {\text{Z}}_{i}^{t} + {\text{U}}_{i}^{t}\right‖ \begin{matrix}2 \\ F\end{matrix} ,$$

$${\text{minimize}}_{\left\{{\text{Z}}_{i}\right\}} {\sum }_{i = 1}^{N} g i \left({\text{Z}}_{i}\right) + {\sum }_{i = 1}^{N} \frac{{ρ}_{i}}{2} \left‖{\text{W}}_{i}^{t + 1} - {\text{Z}}_{i} + {\text{U}}_{i}^{t}\right‖ \begin{matrix}2 \\ F\end{matrix} ,$$

where Ui denotes dual variable and t is the iteration index, and we update Ui in each iteration by

$${\text{U}}_{i}^{t} : = {\text{U}}_{i}^{t - 1} + {\text{W}}_{i}^{t} - {\text{Z}}_{i}^{t} .$$

These two subproblems will be iteratively solved until convergence.

The first subproblem can be solved by classic SGD.

For the second subproblem, the solution is given by

$${\text{Z}}_{i}^{t + 1} = {\prod }_{{\text{S}}_{i}} \left({\text{W}}_{i}^{t + 1} + {\text{U}}_{i}^{t}\right) ,$$

where ΠSi (*) is the Euclidean projection to Si, thereby guarantees weight matrices are subjected to hardware-aware BCR sparsity.

Layerwise pruning rates are the hyperparameters in the ADMM-based solution framework. We use a straightforward, uniform target pruning rate for all layers in the DNN. This is shown as a valid hyperparameter setting for overall acceleration. More sophisticated hyperparameter determination procedure is possible and is orthogonal to this work.

### Evaluation

This section evaluates BPDNN by comparing it with TVM [6], TFLITE [1], MNN [2], and an optimized sparse matrix implementation (CSR) based on CSR [8].

### Methodology

Evaluation Objective. Our evaluation has four objectives: (1) proving BCR pruning results in both high compression rates and accuracy by comparing it with several state-of-the-art model compression efforts; (2) demonstrating BPDNN runs faster than state-of-the-art end-to-end DNN execution frameworks, achieving real-time execution of mainstream DNNs on mobile devices without any accuracy compromise; (3) studying the performance impact of BPDNN’s major compiler optimizations and the underlying reasons of the performance gains; (4) validating BPDNN’s good portability by comparing it with other frameworks on two other mobile devices.

Models and Datasets. BPDNN is evaluated on three mainstream CNNs, VGG-16 (VGG), ResNet-18 (RNT), and MobileNet-V2 (MBNT). They are trained and tested on two datasets, ImageNet and CIFAR-10. BPDNN is also evaluated on a popular GRU RNN model that is widely used in previous studies [9, 25, 39]. GRU contains 2 GRU layers and about 9.6 M parameters. GRU is trained and tested on the TIMIT dataset [7] that is commonly used for evaluating automatic speech recognition systems.

Test-bed and Evaluation Setup. Our evaluations are conducted on a cell phone, Samsung Galaxy S10 with the latest Qualcomm Snapdragon 855 that consists of a Qualcomm Kryo 485 Octa-core CPU and a Qualcomm Adreno 640 GPU. The portability is tested on a Xiaomi POCOPHONE F1 phone with a Qualcomm Snapdragon 845 that consists of a Kryo 385 Octa-core CPU and an Adreno 630 GPU, and an Honor Magic 2 phone with a Kirin 980 that consists of an ARM Octa-core CPU and a Mali-G76 GPU. All experiments run 50 times on varied input with 8 threads on CPU, and all pipelines on GPU. Multiple runs do not vary severely, so we only report the average execution time for read-ability. We tune all runs to their best configurations, e.g., we apply Winograd optimization [23] for all dense runs, and use 16-bit float point for all GPU runs.

### Accuracy Report

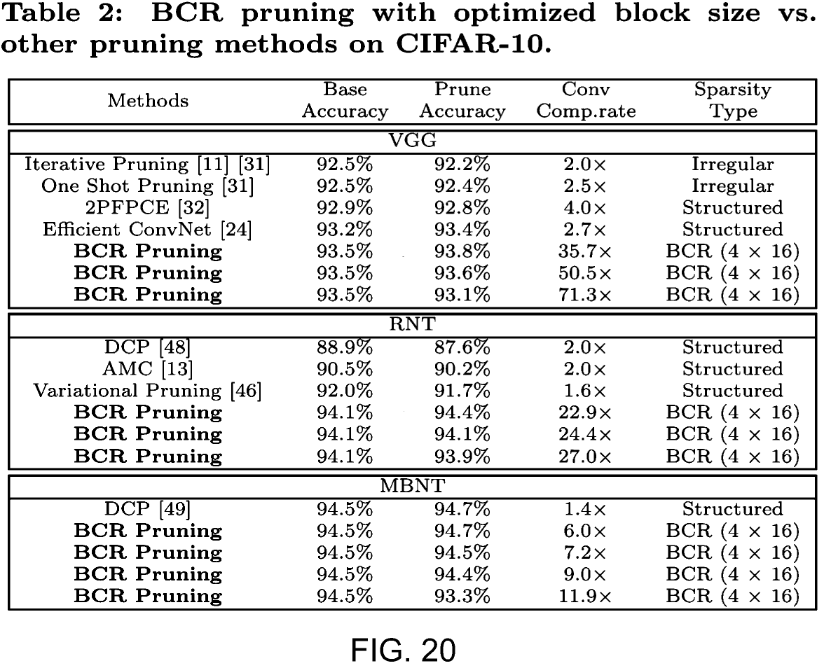

CIFAR-10. As shown in Table 2 (FIG. 20), we perform BCR pruning based on the pre-trained VGG, RNT and MBNT models. For VGG, the original accuracy of the pre-trained model is 93.5%. Compared with the original model, we achieve up to 50.5x weight pruning rate without any accuracy degradation and 71.3x with only 0.4% accuracy loss. As for RNT, the original accuracy can be maintained as 94.1% when weight pruning rate is 24.4x. Even with the weight pruning rate of 27.0x, the accuracy degradation is still negligible. For MBNT, we achieve 9x compression rate with minor accuracy loss compared with the original model (94.5%). Considering MBNT is already an extremely small network, this weight pruning result is still prominent.

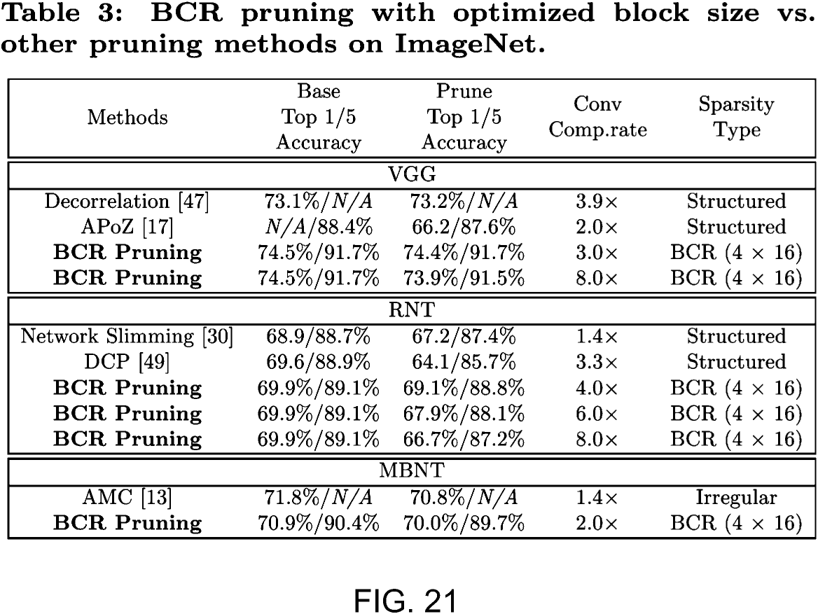

ImageNet. Table 3 (FIG. 21) shows the weight pruning results of VGG, RNT and MBNT. For VGG, we achieve up to 8x weight pruning rate with minor accuracy loss compared with the original model (top-5 accuracy 91.7%); for RNT, top-5 accuracy loss is negligible when pruning rate is 4x; for MBNT, we get 2x pruning rate with 0.7% degradation in top-5 accuracy.

Here, for CIFAR-10 and ImageNet, we use the optimized block size with 4 rows and 16 columns for each network.

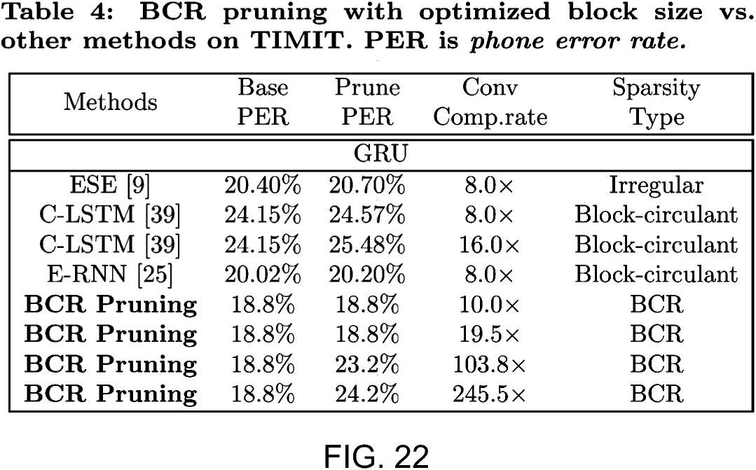

TIMIT. Table 4 (FIG. 22) illustrates the weight pruning results (including phone error rate and compression rate) of BCR and the comparison with other state-of-the-art methods, including ESE [9], C-LSTM [39], E-RNN [25] on the same dataset TIMIT. According to the table, we can observe that when it comes to low compression rates (not higher than 20x), the BCR can guarantee no accuracy degradation (10x) or extremely slight degeneration (19x), which over-weighs ESE (8x) and C-LSTM (8x &.16x) in terms of both compression rate and inference accuracy; when it comes to high compression rates (such as 103x), the BCR can maintain an admirable speech recognition performance, which means the BCR pruned model can even outperform the C-LSTM baseline model from both compression rate and accuracy; Moreover, the BCR method can well adapt to ultra-high compression rate scenario. For example, our model with 245x compression rate can still maintain the same-level PER as the C-LSTM baseline model (24.20% vs. 24.15%).

Compared with prior work, BCR consistently achieves higher pruning rates without or with minor accuracy degradation on varied networks and varied datasets.

### Overall Execution Time Report

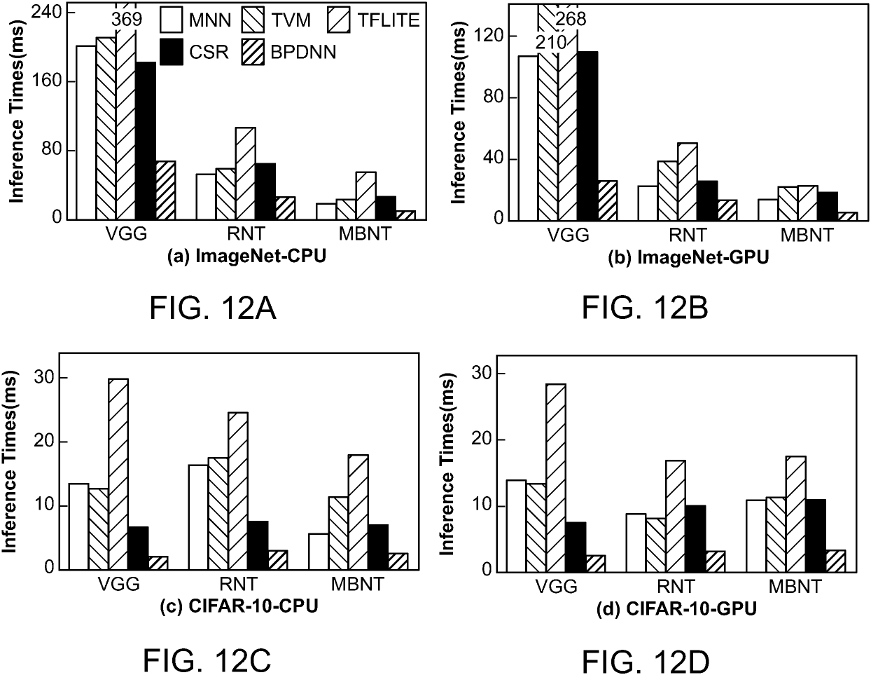

FIGS. 12A-12D report BPDNN’s CPU and GPU execution performance, and compares BPDNN with MNN, TVM, TFLITE, and CSR on three CNNs (VGG, RNT, and MBNT) trained on two datasets (ImageNet and CIFAR-10), respectively. (Models w/ highest comp. rate in Table 2 to 4 (FIGS. 20-22) are selected.) BPDNN outperforms other frameworks for all cases. On CPU, BPDNN achieves 1.96x to 5.31x, 2.26x to 4.97x, 4.09x to 11.58x, and 2.36x to 2.78x speedup over MNN, TVM, TFLITE, and CSR, respectively. On GPU, BPDNN achieves 1.7x to 5.72x, 2.62 to 7.54x, 3.87x to 11.76x, and 1.95x to 4.19x speedup over MNN, TVM, TFLITE, and CSR, respectively. For the largest CNN (VGG) trained on the largest dataset (ImageNet), BPDNN can complete the whole inference of a single input within 33 ms with our mobile GPU, meeting the industrial real-time standard (i.e., 30 frames/sec).

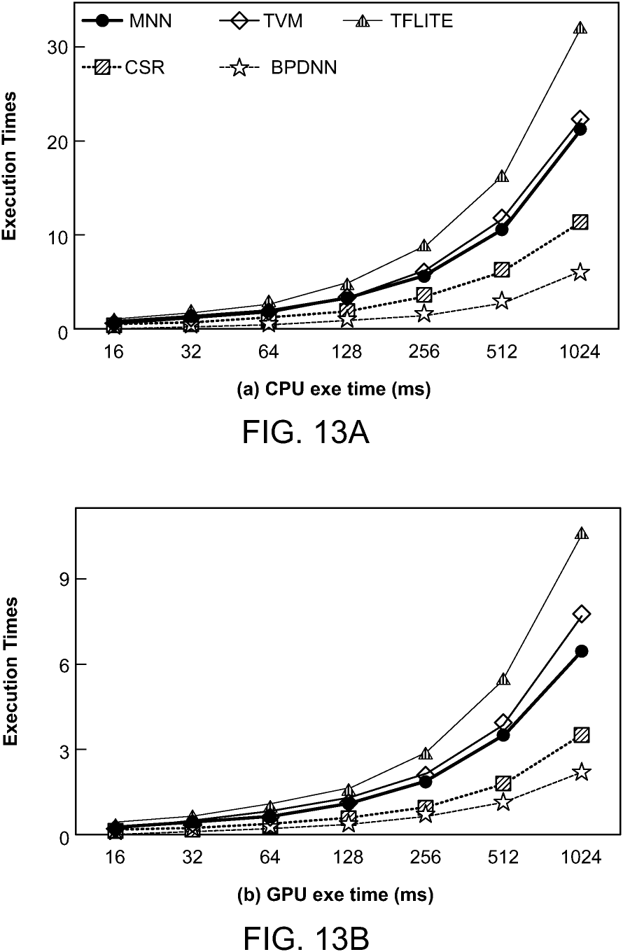

For GRU RNN, because other frameworks do not support end-to-end execution on mobile platforms. We compare BPDNN with others on matrix multiplication kernels with varied sizes. The weight matrix is pruned with a 10x compression rate. FIGS. 13A-13B report the result. All frameworks' execution time increases as the matrix size grows. BPDNN performs the best, with up to 2.3x, 4.3x, 6.1x, and 2.5x speedup over MNN, TVM, TFLITE, and CSR. BPDNN completes GRU inference on Adreno 640 GPU within 81 us (for sequence length of 1 and batch size of 32). We compare BPDNN with a representative FPGA implementation, ESE [11]. BPDNN can even slightly outperform ESE. (ESE complete GRU around 82 us.)

### Performance Optimizations Break-Down

Although the overall computation workload is significantly reduced with our BCR pruning, the DNN execution performance is not improved obviously without further compiler optimizations due to the computation and memory access irregularity. This part carefully studies the impact of BPDNN’s compiler optimizations. These optimizations are only enabled by BCR pruning. Existing weight pruning methods cannot support these optimizations, so they perform similarly to BPDNN without these optimizations.

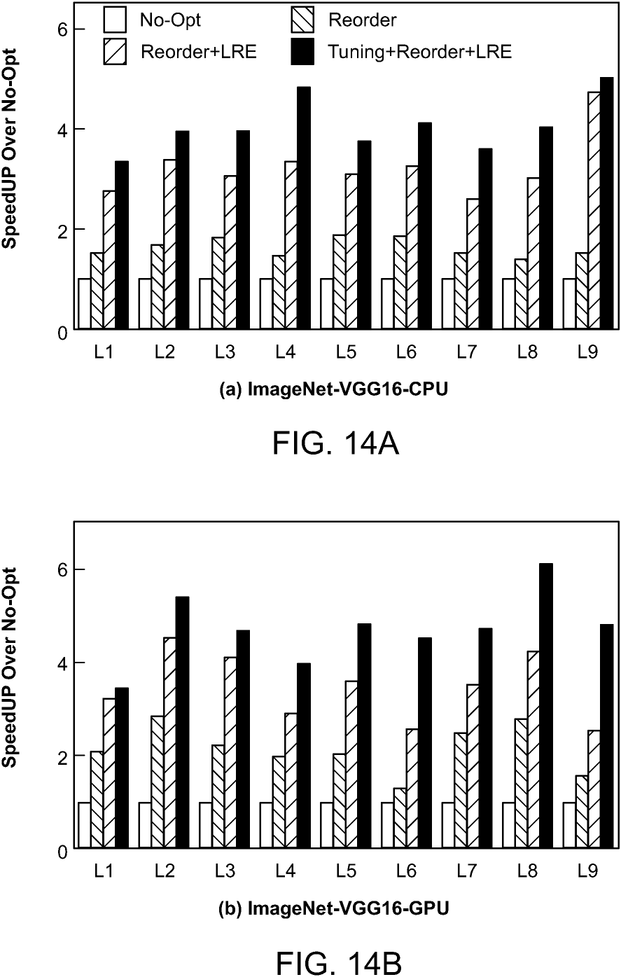

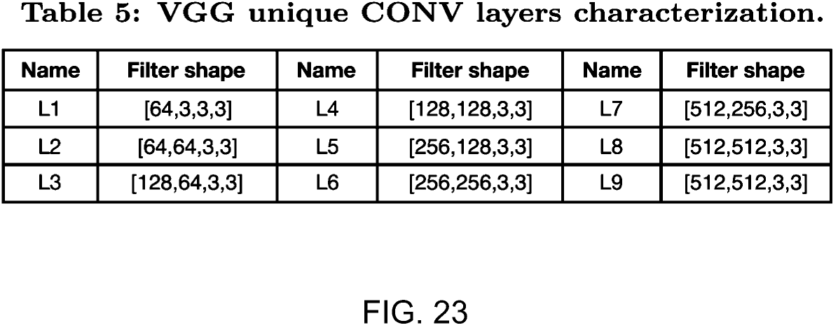

FIGS. 14A-14B show the performance improvement given by each optimization for VGG (on ImageNet). (The RNN and other CNN results are omitted due to the space constraints. They are very similar to VGG.) The x-axis denotes the unique layers in VGG, and more detailed information is shown in Table 5 (FIG. 23). This result uses the code on BCR pruned models without any optimization (No-Opt) as the evaluation baseline. On CPU, matrix reorder (Reorder) brings 1.21x to 1.88x speedup, register-level load redundancy elimination brings extra 1.11x to 3.51x speedup, and auto-tuning brings additional 0.31x to 1.45x speedup. On GPU, these numbers are 1.30x to 2.88x, 0.89x to 1.90x, and 0.19x to 2.28x, respectively. Matrix reorder optimization yields more benefits on GPU than CPU, because GPU has more threads and hence is more sensitive to thread divergence and load imbalance. We next characterize matrix reorder, load redundancy elimination, and compact storage optimizations to explain why they work. Auto-tuning and other optimizations are not further explained because their effects are more straightforward.

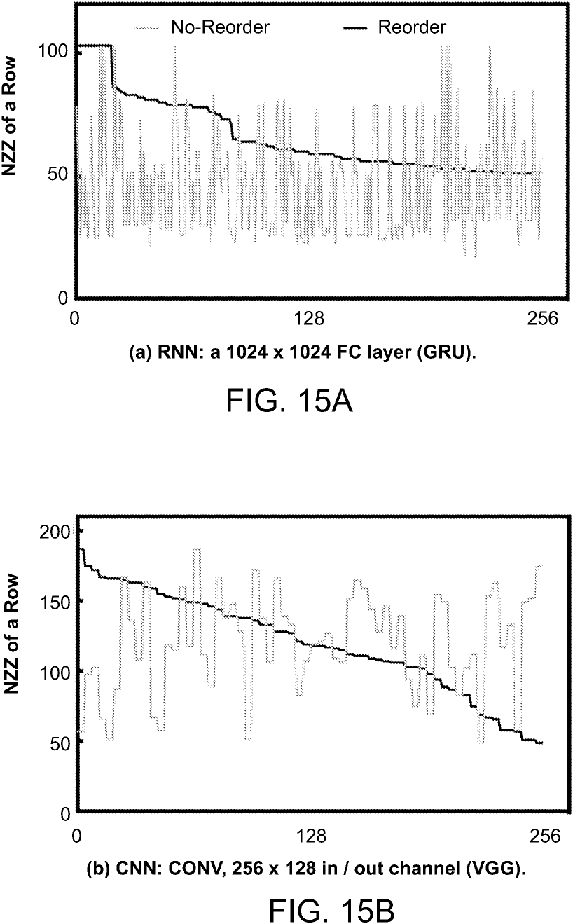

Effect of Matrix Reorder. FIGS. 15A-15B show the number of non-zero weights (nnz) in each row for an RNN FC layer and a CNN CONV layer, respectively. Only the first 256 rows are plotted for readability. The nnz distribution is very random before matrix reorder (No-Reorder), incurring significant thread divergence and load imbalance if these rows are processed by different threads. This distribution becomes much more regular after reorder (Reorder). The rows with similar nnzs can be grouped together and each group can be processed by all threads simultaneously to minimize thread divergence and load imbalance.

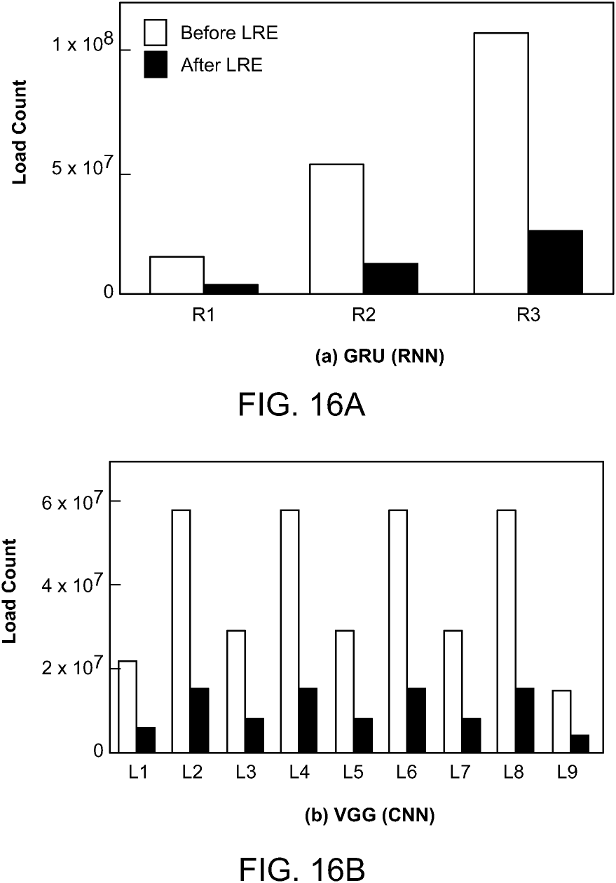

Effect of LRE. FIGS. 16A-16B report the register load counts before and after the load redundancy elimination for multiple layers with different matrix sizes from both GRU (RNN) and VGG(CNN). It shows the number of register loads are significantly reduced with LRE optimization. This explains why LRE yields so obvious performance gains even after the traditional data locality optimizations like tiling.

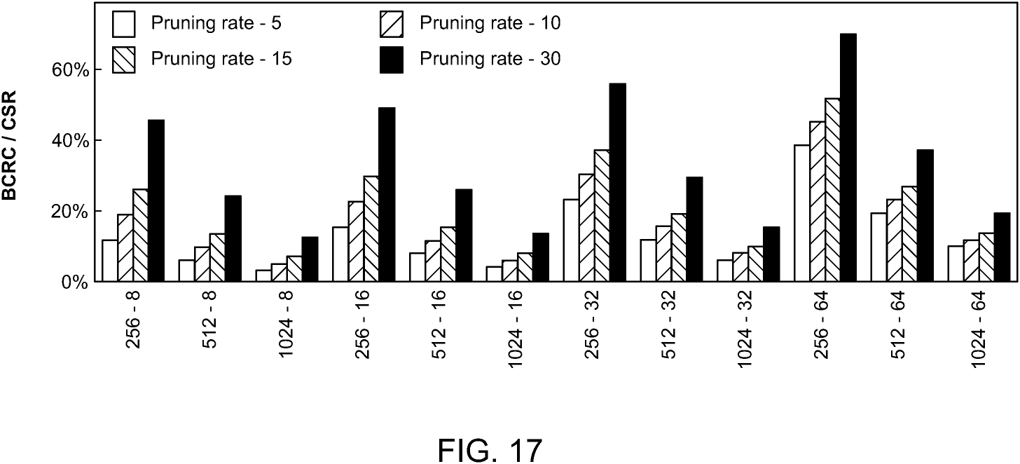

BCRC VS CSR. FIG. 17 shows the extra data storage overhead (i.e., the data size other than non-zero weights) for both BCRC and CSR with varied matrix sizes and pruning rates. It shows BCRC can save 61.7% to 97.1%, 54.9% to 95.2%, 48.3% to 93.3%, and 30.1% to 87.7% extra data over CSR for different pruning rates. This results in up to 48.5%, 47.6%, 46.6%, and 43.8% overall data reduction for different pruning rates.

### Portability Evaluation

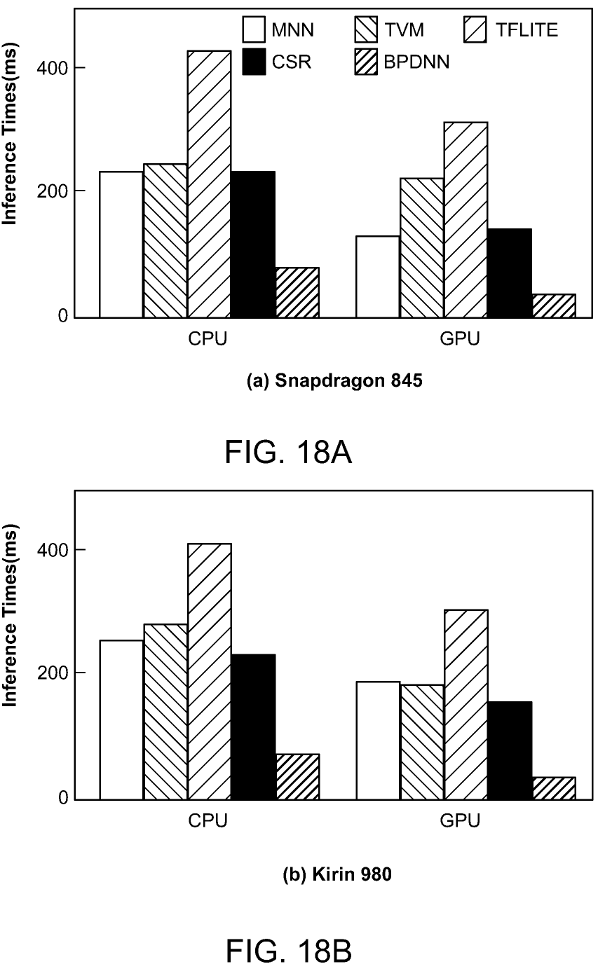

We also ran BPDNN on two other cell phones to validate its portability. We got very similar performance comparison results as above. FIGS. 18A-18B report the performance comparison of VGG (the most complex/largest DNN in our evaluation) between BPDNN and others frameworks. On both platforms, BPDNN outperforms others for both CPU and GPU, demonstrating BPDNN’s good performance portability. The design and optimizations of BPDNN are general, not specific to any brand or type mobile devices. BPDNN is also less sensitive to the resources constraints because of its high compression rate, so its performance is stable on other mobile devices with even weaker computation power and smaller memory capabilities (e.g., Raspberry Pi).

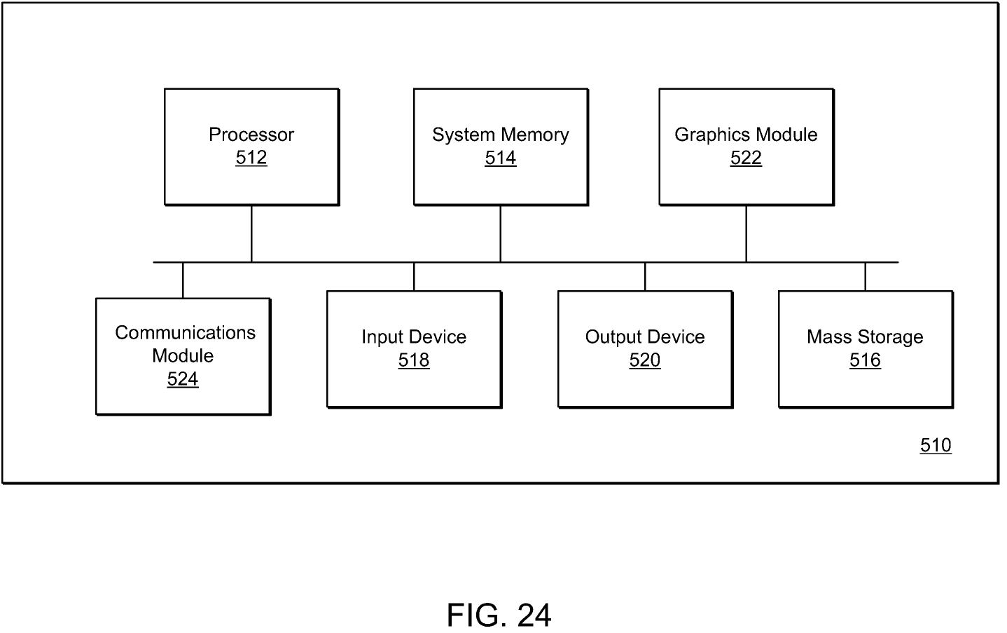

The methods, operations, modules, and systems described herein may be implemented in one or more computer programs executing on a programmable computer system. FIG. 24 is a simplified block diagram illustrating an exemplary computer system 510, on which the one or more computer programs may operate as a set of computer instructions. The computer system 510 includes, among other things, at least one computer processor 512, system memory 514 (including a random access memory and a read-only memory) readable by the processor 512. The computer system 510 also includes a mass storage device 516 (e.g., a hard disk drive, a solid-state storage device, an optical disk device, etc.). The computer processor 512 is capable of processing instructions stored in the system memory or mass storage device. The computer system additionally includes input/output devices 518, 520 (e.g., a display, keyboard, pointer device, etc.), a graphics module 522 for generating graphical objects, and a communication module or network interface 524, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

### REFERENCES

https://www.tensorflow.org/mobile/tflite/.

https://github.com/alibaba/MNN.

BHATTACHARYA, S., AND LANE, N. D. From smart to deep: Robust activity recognition on smartwatches using deep learning. In 2016 IEEE International Conference on Pervasive Computing and Communication Workshops (PerCom Workshops) (2016), IEEE, pp. 1-6.

BOTICKI, I., AND SO, H.-J. Quiet captures: A tool for capturing the evidence of seamless learning with mobile devices. In International Conference of the Learning Sciences-Volume 1 (2010).

BOYD, S., PARIKH, N., CHU, E., PELEATO, B., AND ECKSTEIN, J. Distributed optimization and statistical learning via the alternating direction method of multipliers. Foundations and Trends in Machine Learning 3, 1 (2011), 1-122.

CHEN, T., MOREAU, T., JIANG, Z., ZHENG, L., YAN, E., SHEN, H., COWAN, M., WANG, L., HU, Y., CEZE, L., ET AL. TVM: An automated end-to-end optimizing compiler for deep learning. In OSDI (2018).

GAROFOLO, J. S., LAMEL, L. F., FISHER, W. M., FISCUS, J. G., PALLETT, D. S., DAHLGREN, N. L., AND ZUE, V. Timit acoustic-phonetic continuous speech corpus. Linguistic data consortium 10, 5 (1993), 0.

GREATHOUSE, J. L., KNOX, K., PO LA, J., VARAGANTI, K., AND DAGA, M. clsparse: A vendor-optimized open-source sparse blas library. In Proceedings of the 4th International Workshop on OpenCL (2016), ACM, p. 7.

HAN, S., KANG, J., MAO, H., HU, Y., LI, X., LI, Y., XIE, D., LUO, H., YAO, S., WANG, Y., YANG, H., AND DALLY, W. J. Ese: Efficient speech recognition engine with sparse lstm on fpga. In FPGA (2017), pp. 75-84.

HAN, S., MAO, H., AND DALLY, W. J. Deep compression: Compressing deep neural networks with pruning, trained quantization and Huffman coding. arXiv preprint arXiv:1510.00149 (2015).

HAN, S., POOL, J., TRAN, J., AND DALLY, W. Learning both weights and connections for efficient neural network. In Advances in Neural Information Processing Systems (2015), pp. 1135-1143.

HAN, S., SHEN, H., PHILIPOSE, M., AGARWAL, S., WOLMAN, A., AND KRISHNAMURTHY, A. Mcdnn: An approximation-based execution framework for deep stream processing under resource constraints. In Proceedings of the 14th Annual International Conference on Mobile Systems, Applications, and Services (2016), ACM, pp. 123-136.

HE, Y., LIN, J., LIU, Z., WANG, H., LI, L.-J., AND HAN, S. Amc: Automl for model compression and acceleration on mobile devices. In European Conference on Computer Vision (2018), pp. 815-832.

HE, Y., ZHANG, X., AND SUN, J. Channel pruning for accelerating very deep neural networks. In Computer Vision (ICCV), 2017 IEEE International Conference on (2017), IEEE, pp. 1398-1406.

HILL, P., JAIN, A., HILL, M., ZAMIRAI, B., HSU, C.-H., LAURENZANO, M. A., MAHLKE, S., TANG, L., AND MARS, J. Deftnn: Addressing bottlenecks for dnn execution on GPUs via synapse vector elimination and near-compute data fission. In Proceedings of the 50th Annual IEEE/ACM International Symposium on Microarchitecture (2017), ACM, pp. 786-799.

HONG, M., LUO, Z.-Q., AND RAZAVIYAYN, M. Convergence analysis of alternating direction method of multipliers for a family of nonconvex problems. SIAM Journal on Optimization 26, 1 (2016), 337-364.

HU, H., PENG, R., TAI, Y.-W., AND TANG, C.-K. Network trimming: A data-driven neuron pruning approach towards efficient deep architectures. arXiv preprint arXiv: 1607.03250 (2016).

HUYNH, L. N., LEE, Y., AND BALAN, R. K. Deepmon: Mobile gpu-based deep learning framework for continuous vision applications. In Proceedings of the 15th Annual International Conference on Mobile Systems, Applications, and Services (2017), ACM, pp. 82-95.

KINGMA, D. P., AND BA, J. Adam: A method for stochastic optimization. In Proceedings of the International Conference on Learning Representations (ICLR) (2014).

LANE, N. D., BHATTACHARYA, S., GEORGIEV, P., FORLIVESI, C., JIAO, L., QENDRO, L., AND KAWSAR, F. Deepx: A software accelerator for low-power deep learning inference on mobile devices. In Proceedings of the 15th International Conference on Information Processing in Sensor Networks (2016), IEEE Press, p. 23.

LANE, N. D., BHATTACHARYA, S., GEORGIEV, P., FORLIVESI, C., AND KAWSAR, F. An early resource characterization of deep learning on wearables, smartphones and internet-of-things devices. In International workshop on IOT towards applications (2015).

LANE, N. D., GEORGIEV, P., AND QENDRO, L. Deepear: robust smartphone audio sensing in unconstrained acoustic environments using deep learning. In Proceedings of the 2015 ACM International Joint Conference on Pervasive and Ubiquitous Computing (2015), ACM, pp. 283-294.

LAVIN, A., AND GRAY, S. Fast algorithms for convolutional neural networks. In Proceedings of the IEEE Conference on Computer Vision and Pattern Recognition (2016), pp. 4013-4021.

LI, H., KADAV, A., DURDANOVIC, I., SAMET, H., AND GRAF, H. P. Pruning filters for efficient convnets. arXiv preprint arXiv: 1608.08710 (2016).

LI, Z., DING, C., WANG, S., WEN, W., ZHUO, Y., LIN, X., QIAN, X., AND WANG, Y. E-rnn: design optimization for efficient recurrent neural networks in fpgas. In High Performance Computer Architecture (HPCA), 2019 IEEE International Symposium on (2019), IEEE.

LIU, B., WANG, M., FOROOSH, H., TAPPEN, M., AND PENSKY, M. Sparse convolutional neural networks. In CVPR (2015), pp. 806-814.

LIU, S., CHEN, J., CHEN, P.-Y., AND HERO, A. Zeroth-order online alternating direction method of multipliers: Convergence analysis and applications. In International Conference on Artificial Intelligence and Statistics (2018), pp. 288-297.

LIU, S., LIN, Y., ZHOU, Z., NAN, K., LIU, H., AND DU, J. On-demand deep model compression for mobile devices: A usage-driven model selection framework. In Proceedings of the 16th Annual International Conference on Mobile Systems, Applications, and Services (2018), ACM, pp. 389-400.

LIU, Z., LI, J., SHEN, Z., ET AL. Learning efficient convolutional networks through network slimming. In ICCV (2017).

LIU, Z., LI, J., SHEN, Z., HUANG, G., YAN, S., AND ZHANG, C. Learning efficient convolutional networks through network slimming. In Proceedings of the IEEE International Conference on Computer Vision (2017), pp. 2736-2744.

LIU, Z., SUN, M., ZHOU, T., HUANG, G., AND DARRELL, T. Rethinking the value of network pruning. arXiv preprint arXiv:1810.05270 (2018).

MIN, C., WANG, A., CHEN, Y., XU, W., AND CHEN, X. 2pfpce: Two-phase filter pruning based on conditional entropy. arXiv preprint arXiv: 1809.02220 (2018).

PARASHAR, A., RHU, M., MUKKARA, A., PUGLIELLI, A., VENKATESAN, R., KHAILANY, B., EMER, J., KECKLER, S. W., AND DALLY, W. J. Scnn: An accelerator for compressed-sparse convolutional neural networks. In ISCA (2017).

PHILIPP, D., DURR, F., AND ROTHERMEL, K. A sensor network abstraction for flexible public sensing systems. In 2011 IEEE Eighth International Conference on Mobile Ad-Hoc and Sensor Systems (2011), IEEE, pp. 460-469.

REN, A., ZHANG, T., YE, S., XU, W., QIAN, X., LIN, X., AND WANG, Y. Admm-nn: an algorithm-hardware co-design framework of dnns using alternating direction methods of multipliers. In ASPLOS (2019).

RODGERS, M. M., PAI, V. M., AND CONROY, R. S. Recent advances in wearable sensors for health monitoring. IEEE Sensors Journal 15, 6 (2014), 3119-3126.

SIMONYAN, K., AND ZISSERMAN, A. Very deep convolutional networks for large-scale image recognition. arXiv preprint arXiv:1409.1556 (2014).

VASILACHE, N., ZINENKO, O., THEODORIDIS, T., GOYAL, P., DEVITO, Z., MOSES, W. S., VERDOOLAEGE, S., ADAMS, A., AND COHEN, A. Tensor comprehensions: Framework-agnostic high-performance machine learning abstractions. arXiv preprint arXiv:1802.04730 (2018).

WANG, S., LI, Z., DING, C., YUAN, B., QIU, Q., WANG, Y., AND LIANG, Y. C-lstm: Enabling efficient lstm using structured compression techniques on fpgas. In Proceedings of the 2018 ACM/SIGDA International Symposium on Field-Programmable Gate Arrays (2018), ACM, pp. 11-20.

WEN, W., WU, C., WANG, Y., CHEN, Y., AND LI, H. Learning structured sparsity in deep neural networks. In Advances in neural information processing systems (2016), pp. 2074-2082.

XU, M., ZHU, M., LIU, Y., LIN, F. X., AND LIU, X. Deepcache: Principled cache for mobile deep vision. In Proceedings of the 24th Annual International Conference on Mobile Computing and Networking (2018), ACM, pp. 129-144.

YAO, S., HU, S., ZHAO, Y., ZHANG, A., AND ABDELZAHER, T. Deepsense: A unified deep learning framework for time-series mobile sensing data processing. In Proceedings of the 26th International Conference on World Wide Web (2017).

YE, S., FENG, X., ZHANG, T., MA, X., LIN, S., LI, Z., XU, K., WEN, W., LIU, S., TANG, J., ET AL. Progressive dnn compression: A key to achieve ultra-high weight pruning and quantization rates using admm. arXiv preprint arXiv:1903.09769 (2019).

ZHANG, T., YE, S., ZHANG, Y., WANG, Y., AND FARDAD, M. Systematic weight pruning of dnns using alternating direction method of multipliers. arXiv preprint arXiv:1802.05747 (2018).

ZHANG, T., ZHANG, K., YE, S., LI, J., TANG, J., WEN, W., LIN, X., FARDAD, M., AND WANG, Y. Adam-admm: A unified, systematic framework of structured weight pruning for dnns. arXiv preprint arXiv:1807.11091 (2018).

ZHAO, C., NI, B., ZHANG, J., ET AL. Variational convolutional neural network pruning. In CVPR (2019).

ZHU, X., ZHOU, W., AND LI, H. Improving deep neural network sparsity through decorrelation regularization. In IJCAI (2018).

ZHUANG, Z., TAN, M., ZHUANG, B., ET AL. Discrimination-aware channel pruning for deep neural networks. In NIPS (2018).

ZHUANG, Z., TAN, M., ZHUANG, B., LIU, J., GUO, Y., WU, Q., HUANG, J., AND ZHU, J. Discrimination-aware channel pruning for deep neural networks. In Advances in Neural Information Processing Systems (2018), pp. 875-886.

1. A computer-implemented method for compressing a deep neural network (DNN) model by DNN weight pruning and accelerating DNN execution in a mobile device to achieve real-time inference, the method comprising the steps of:
(a) performing fine-grained structured weight pruning of the DNN model by applying independent row and column pruning to each block of a weight matrix of the DNN model; and
(b) applying a compiler-assisted DNN acceleration framework to the DNN model pruned in (a) to generate code to be executed on the mobile device using one or more compiler optimizations.

2. The method of claim 1, further comprising applying an optimization framework to determine a block size to be used in performing the fine-grained structured weight pruning of step (a).

3. The method of claim 1, wherein the DNN is a Convolution Neural Network (CNN) or a Recurrent Neural Network (RNN).

4. The method of claim 1, wherein the one or more optimizations are applicable to a CPU or a GPU of the mobile device.

5. The method of claim 1, wherein the one or more optimizations includes performing a matrix reorder based on the DNN model pruned in (a) to increase the computation regularity and improve intra-and inter-thread parallelism.

6. The method of claim 5, further comprising storing the DNN model in a compact format after performing the matrix reorder.

7. The method of claim 1, wherein the one or more optimizations includes performing a register-level load redundancy elimination in the DNN model to reduce the number of register loads to improve memory performance.

8. The method of claim 1, wherein the one or more optimizations includes automatically tuning configurable performance parameters.

9. A computer system, comprising:
at least one processor;
memory associated with the at least one processor; and
a program supported in the memory for compressing a deep neural network (DNN) model by DNN weight pruning and accelerating DNN execution in a mobile device to achieve real-time inference, the program containing a plurality of instructions which, when executed by the at least one processor, cause the at least one processor to:
(a) perform fine-grained structured weight pruning of the DNN model by applying independent row and column pruning to each block of a weight matrix of the DNN model; and
(b) apply a compiler-assisted DNN acceleration framework to the DNN model pruned in (a) to generate code to be executed on the mobile device using one or more compiler optimizations.

10. The computer system of claim 9, wherein the program further comprises instructions for applying an optimization framework to determine a block size to be used in performing the fine-grained structured weight pruning of (a).

11. The computer system of claim 9, wherein the DNN is a Convolution Neural Network (CNN) or a Recurrent Neural Network (RNN).

12. The computer system of claim 9, wherein the one or more optimizations are applicable to a CPU or a GPU of the mobile device.

13. The computer system of claim 9, wherein the one or more optimizations includes performing a matrix reorder based on the DNN model pruned in (a) to increase the computation regularity and improve intra-and inter-thread parallelism.

14. The computer system of claim 13, wherein the program further comprises instructions for storing the DNN model in a compact format after performing the matrix reorder.

15. The computer system of claim 9, wherein the one or more optimizations includes performing a register-level load redundancy elimination in the DNN model to reduce the number of register loads to improve memory performance.

16. The computer system of claim 9, wherein the one or more optimizations includes automatically tuning configurable performance parameters.
